(19) United States
(12) Patent Application Publication
(10) Pub. No.: US 2013/0026739 A1
(43) Pub. Date: Jan. 31, 2013

(54) Golf Cart Folding Device

(71) Applicant: Gordon Liao, Tainan City (TW)

(72) Inventor: Gordon Liao, Tainan City (TW)

(21) Appl. No.: 13/193,711

(22) Filed: Jul. 29, 2011

(51) Int. Cl. B62B 3/02

(52) U.S. Cl. 280/651

(57) ABSTRACT

A golf cart folding device comprises an upper frame having a handle tube at an upper end of the upper frame; a rear wheel stand coupled to the upper frame by a connecting plate, and having a rear wheel at a lower end of the rear wheel stand; a pull rod coupled to the upper frame and the rear wheel stand; a lower frame, coupled to the upper frame, and having a front wheel at a lower end of the lower frame; and a link rod mechanism between the upper and lower frames for drawing the lower frame and the front wheel together towards the rear wheel by the linking of the link rod mechanism when a golf cart is folded, so as to achieve the effects of skipping a step of folding the front wheel, preventing making a user's body or cloth dirty, and providing a simple and easy operation.

### BACKGROUND OF THE INVENTION

1. Field of the Invention

The present invention relates to a golf cart folding device, and more particularly to the golf cart folding device capable of simultaneously drawing a front wheel and a rear wheel together to achieve the effects of skipping the step of additionally folding the front wheel, preventing making a user dirty and providing a simple and easy operation.

2. Description of the Related Art

In a conventional golf cart, it is necessary to fold a front wheel after the whole golf cart is folded, and the procedure generally carried out by the following two methods: (1) A rotating shaft is provided for turning the front wheel to draw the rear wheel together as disclosed in U.S. Pat. No. 6,698,789; and (2) The front wheel is removed, and this method of removing the front wheel requires a reinstallation of the front wheel and may cause troubles and inconvenient if the components of the front wheel are missing. In both methods, the user needs to bend or squat, and then holds the cart frame at a specific inclination by one hand and folds (or removes) the front wheel by the other hand. These methods not only involve a tedious work and a poor posture, but also cause the problem of making the user's body or cloth dirty. Obviously, the conventional way of folding the golf cart is troublesome and inconvenient, and definitely requires improvements.

### SUMMARY OF THE INVENTION

Therefore, it is a primary objective of the present invention to provide a golf cart folding device that can be operated in a simple and convenient manner. When the golf cart is folded, a front wheel and a rear wheel can be drawn together synchronously to skip the step of folding the front wheel again and preventing making the user dirty.

To achieve the aforementioned objective, the present invention comprises:
an upper frame having a handle tube installed at an upper end of the upper frame; and
a rear wheel stand coupled to the upper frame by a connecting plate and having a rear wheel installed at a lower end of the rear wheel stand; a pull rod coupled to the upper frame and the rear wheel stand; a lower frame coupled to the upper frame and having a front wheel at a lower end of the lower frame; and a link rod mechanism installed between the upper and lower frames for drawing the lower frame and the front wheel together towards the rear wheel by the linking of the link rod mechanism when a golf cart is folded, so as to achieve the effects of skipping a step of folding the front wheel, preventing making a user's body or cloth dirty, and providing a simple and easy operation.

### BRIEF DESCRIPTION OF THE DRAWINGS

FIG. 1 is a perspective view of the present invention;

FIG. 2 is an exploded view of a locking mechanism of the present invention;

FIG. 3 is a cross-sectional view of a locking mechanism of the present invention;

FIG. 4 is a schematic view of operating a locking mechanism of the present invention;

FIG. 5 is a first schematic view of folding a golf cart of the present invention;

FIG. 6 is a second schematic view of folding a golf cart of the present invention;

FIG. 7 is a side view of a folded golf cart of the present invention;

FIG. 8 is a side view of another preferred embodiment of the present invention;

FIG. 9 is a first schematic view of folding a golf cart in accordance with another preferred embodiment of the present invention;

FIG. 10 is a second schematic view of folding a golf cart in accordance with another preferred embodiment of the present invention; and

FIG. 11 is a side view of folding a golf cart in accordance with another preferred embodiment of the present invention.

### DETAILED DESCRIPTION OF THE PREFERRED EMBODIMENTS

To make it easier for our examiner to understand the technical characteristics and measures of the present invention to achieve the aforementioned objects and effects, we use two preferred embodiments with related drawings for the detailed description of the present invention as follows.

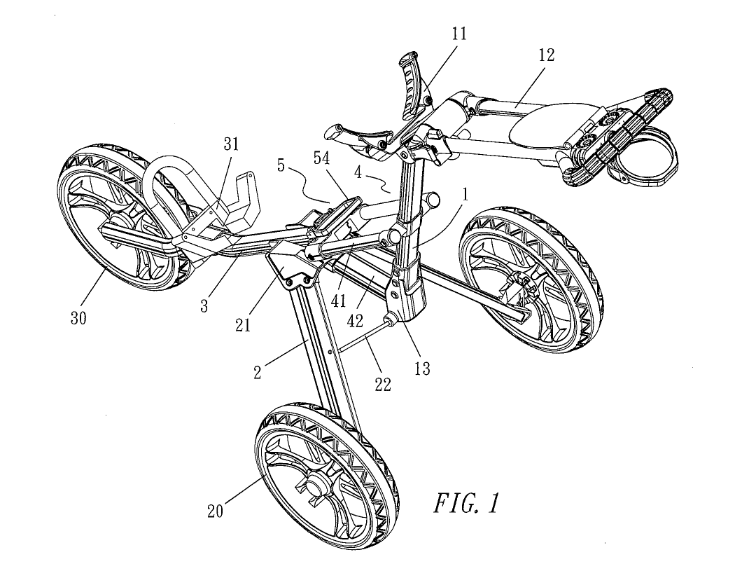

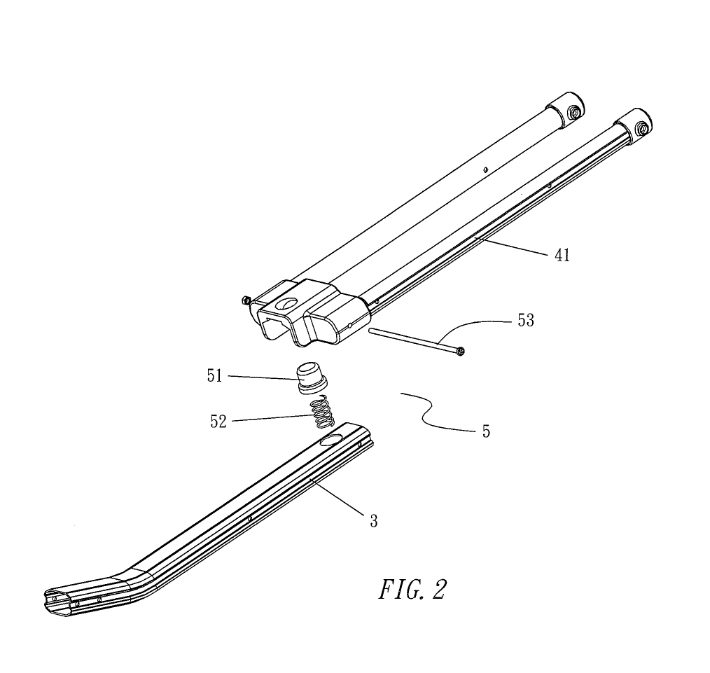

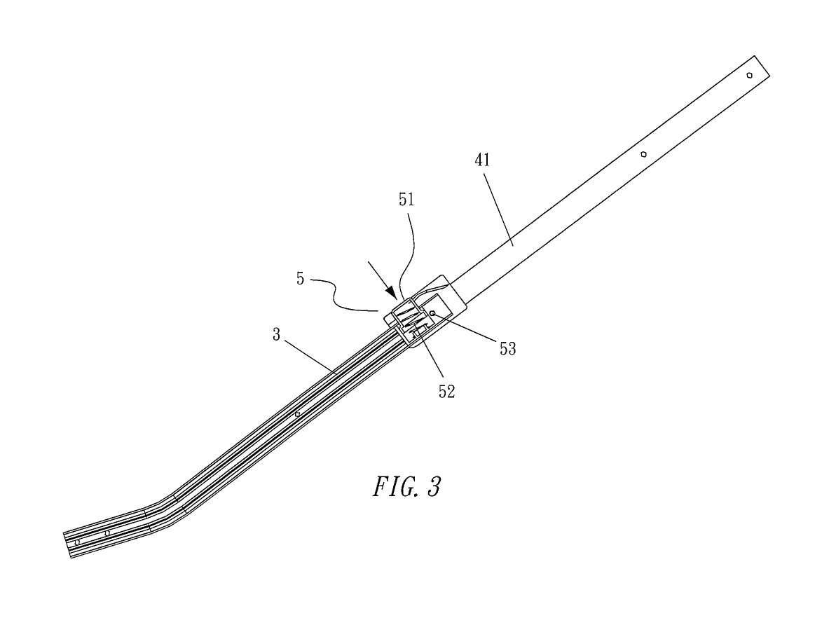

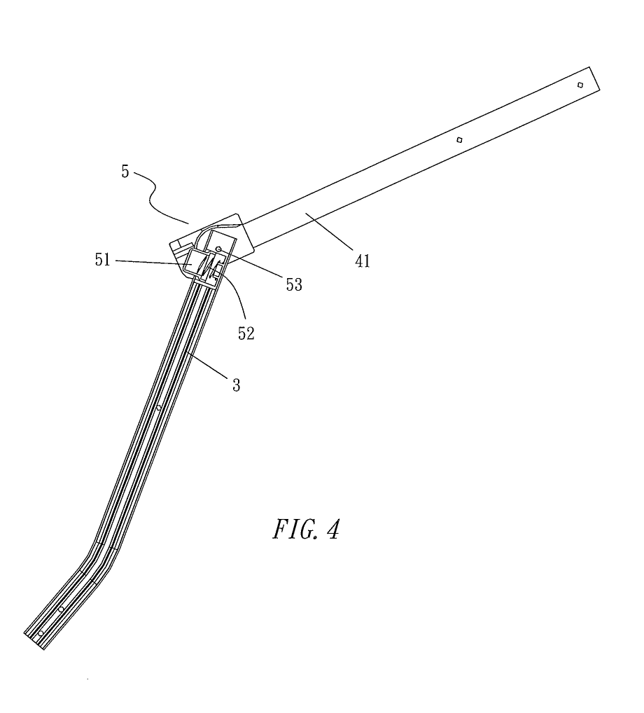

With reference to FIGS. 1 to 4, the present invention comprises:
an upper frame 1, having an upper retaining base 11 disposed at an upper end of the upper frame 1 and coupled to a handle tube 12, and an adapter 13 disposed at a bottom end of the upper frame 1;
a rear wheel stand 2, with an upper end coupled to the upper frame 1 by a connecting plate 21, and a lower end coupled to a rear wheel 20;
a pull rod 22, coupled between the bottom end of the upper frame 1 (adapter 13) and the rear wheel stand 2;
a lower frame 3, with a top end axially coupled to the upper frame 1, and a bottom end having a lower retaining base 31 and a front wheel 30; and
a link rod mechanism 4, installed between the upper and lower frames 1, 3, and including: a first link rod 41, coupled between the upper and lower frames 1, 3; and a second link rod 42, coupled between the bottom end of the upper frame 1 and the connecting plate 21, so that the upper and lower frames 1, 3 and the first and second link rods 41, 42 constitute the link rod mechanism 4; further a locking mechanism 5 being installed between the lower frame 3 and the first link rod 41, and comprising an elastic snap 51 with a compression spring 52 and fixed by a shaft 53, so that the elastic snap 51 is always maintained in situation of being protruded from the first link rod 41 to combine the lower frame 3 and the first link rod 41 linearly, so that when a force is applied to press the elastic snap 51, the locking mechanism 5 can be released to bend the lower frame 3 and the first link rod 41 by using the shaft 53 as an axis as shown in FIG. 4; and the locking mechanism 5 includes a lift handle 54 to facilitate a user's lifting movement.

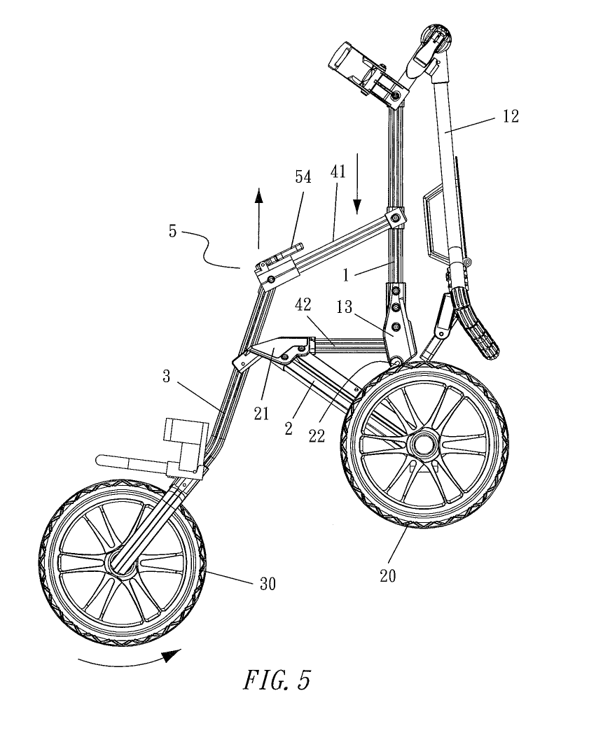

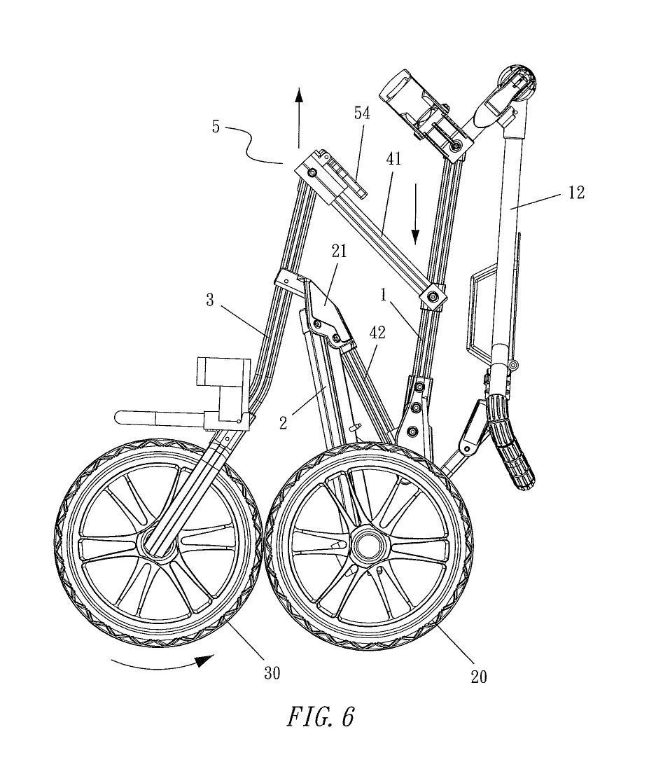

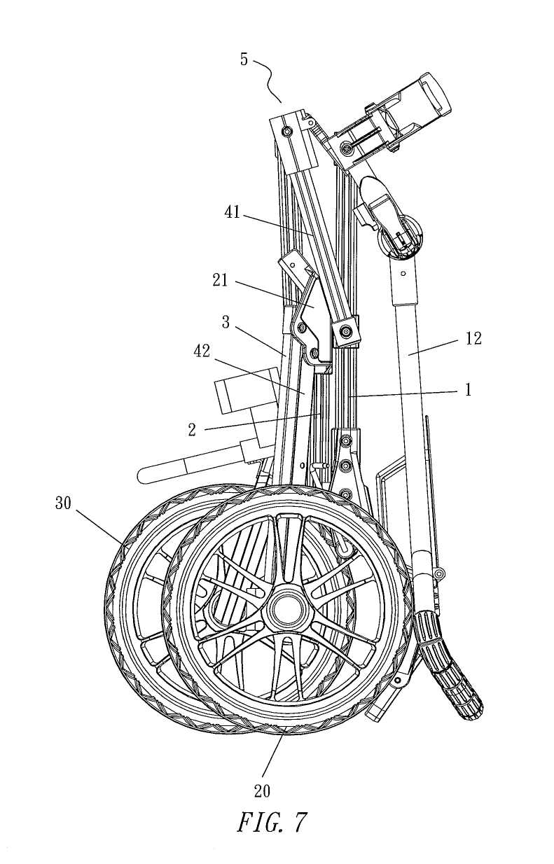

When the golf cart is folded, the handle tube 12 of the upper frame 1 is turned downward, and then the locking mechanism 5 is released and pulled upward, so that the first and second link rods 41, 42 and the upper frame 1 are moved downward by the linking of the first and second link rods 41, 42, and the lower frame 3 and the front wheel 30 are swung backward (in a direction towards the rear wheel 20), so that the rear wheels 30, 20 are drawn together, and the upper and lower frames 1, 3 are stacked with one another as shown in FIGS. 5 to 7. Now, users no longer need to fold the front wheel 30, and the whole golf cart can be attached closely into a smaller storage volume.

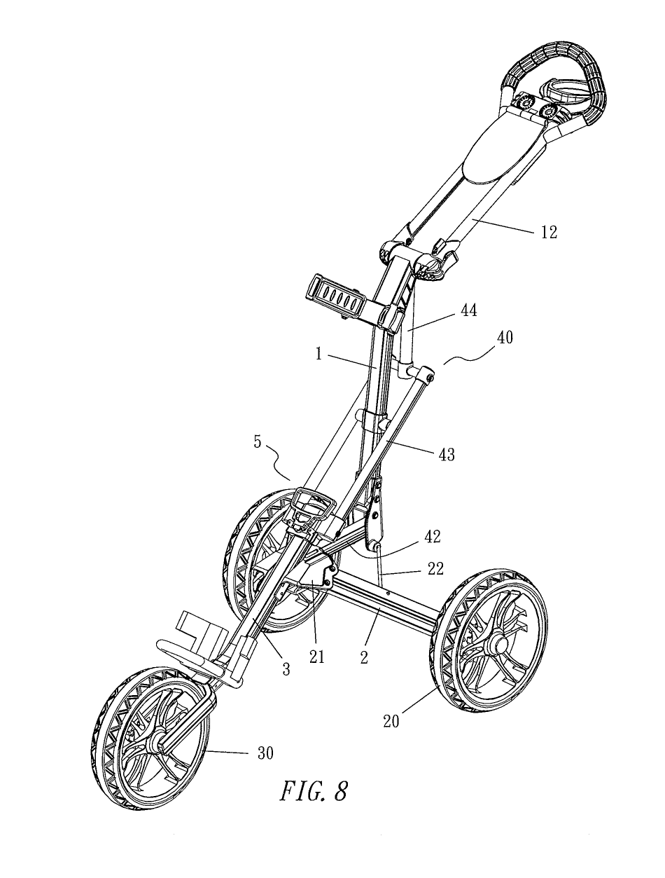

According to the description above, when a golf cart is folded in accordance with the present invention, a user simply release the locking mechanism 5 by lifting the locking mechanism 5 upward to synchronously draw the front wheel 30 and the rear wheel 20 together and fold and stack the upper and lower frames 1, 3 with one another by the linking of the first and second link rods 41, 42 and the pull rod 22. The invention not only provides a simple and convenient operation, but also achieves the effects of skipping the step of folding the front wheel 30 again and preventing making a user's body or cloth dirty. Obviously, the invention improves over the prior art. With reference to FIG. 8 for another preferred embodiment of the present invention, this preferred embodiment is substantially the same as the aforementioned embodiment, except that the first link rod of the link rod mechanism 40 is comprised of third and fourth link rods 43, 44, and the third link rod 43 is axially coupled between the upper and lower frames 1, 3 and has an end protruded out from the upper frame 1, and the fourth link rod 44 is coupled between the third link rod 43 and the handle tube 12 of the upper frame 1.

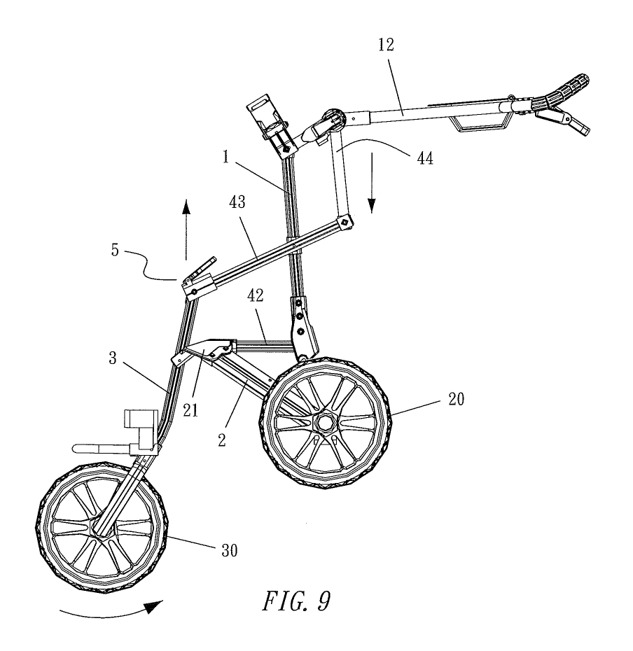

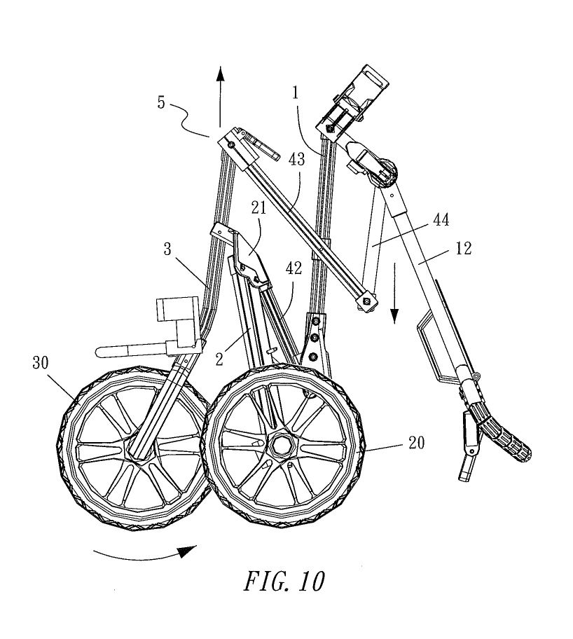

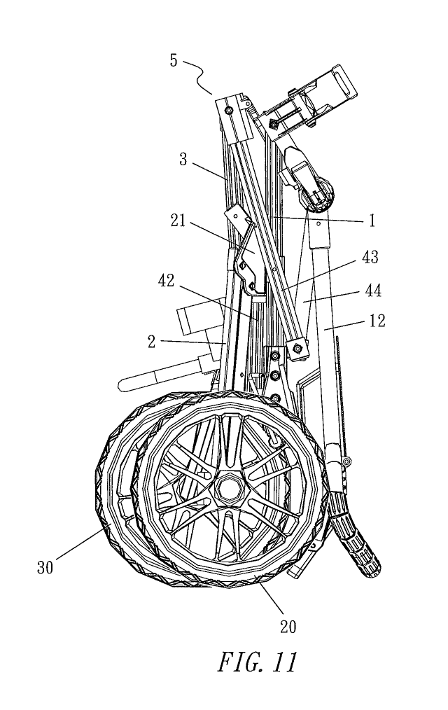

When the golf cart is folded, the locking mechanism 5 is released and pulled upward, such that the upper frame 1 and the handle tube 12 are moved downward and the lower frame 3 and the front wheel 30 are swung backward and drawn closer to the rear wheel 20 by the linking of the third and fourth link rods 43, 44 as shown in FIGS. 9 and 10. Until the golf cart is folded, the front and rear wheels 30, 20 are drawn together as shown in FIG. 11 to achieve the same effect of the previous embodiment. In short, the present invention is characterized in that: (1) The front wheel is fixed to the lower frame; (2) A link rod mechanism is installed between the upper and lower frames, such that when the golf cart is folded, the link rod mechanism can be used for folding the lower frame and drawing the front wheel and the rear wheel together synchronously to achieve the effects of skipping the step of folding the front wheel again, preventing making the user's body or cloth dirty and providing a simple and convenient operation. various modifications and equivalent arrangements of the link rod mechanism can be made without departing from the scope and spirit of the invention set forth in the claims.

In summation of the description above, the present invention improves over the prior art and complies with the patent application requirements, and is thus duly filed for patent application.

What is claimed is:

1. A golf cart folding device, comprising:
an upper frame, having a handle tube at an upper end of the upper frame;
a rear wheel stand, coupled to the upper frame by a connecting plate, and having a rear wheel installed at a lower end;
a pull rod, coupled to the upper frame and the rear wheel stand;
a lower frame, coupled to the upper frame, and having a front wheel installed at a lower end of the lower frame; and
a link rod mechanism, installed between the upper and lower frames, for drawing the lower frame and the front wheel together in a direction towards the rear wheel by the linking of the link rod mechanism when a golf cart is folded, so as to achieve the effects of skipping a step of folding the front wheel, preventing making a user's body or cloth dirty, and providing a simple and easy operation.

2. The golf cart folding device of claim 1, wherein the upper frame includes an adapter installed at a bottom end of the upper frame.

3. The golf cart folding device of claim 1, wherein the upper end of the lower frame is axially coupled to the connecting plate.

4. The golf cart folding device of claim 1, wherein the link rod mechanism comprises:
an upper frame, having a handle tube installed at an upper end of the upper frame;
a lower frame, coupled to an upper end of the lower frame by a connecting plate;
a first link rod, coupled to the upper and lower frames;
a second link rod, coupled to the upper frame and the connecting plate; and
a locking mechanism, installed between the lower frame and the first link rod.

5. The golf cart folding device of claim 4, wherein the first link rod is comprised of third and fourth link rods, and the third link rod is coupled to the upper and lower frames, and has an end protruded outside the upper frame, and the fourth link rod is coupled to the third link rod and the handle tube of the upper frame.

6. The golf cart folding device of claim 4, wherein the locking mechanism include an elastic snap and a shaft.
